(19) United States
(12) Patent Application Publication
(10) Pub. No.: US 2005/0015306 A1
(43) Pub. Date: Jan. 20, 2005

(54) Method and apparatus providing community definition and legacy content development for legacy archives for restricted access by members of the community

(76) Inventor: Carol Fields, Berkeley, CA (US)

Correspondence Address: EARLE JENNINGS, 8 KENYON AVE, KENSINGTON, CA, 94708, US

(21) Appl. No.: 10/655,511

(22) Filed: Sep. 3, 2003

Related U.S. Application Data
(63) Continuation-in-part of application No. 10/607,708, filed on Jun. 27, 2003.

(51) Int. Cl. G06F 17/60

(52) U.S. Cl. 705/26

(57) ABSTRACT

The invention includes mechanisms and methods supporting a first party defining members of a community. Development of at least one legacy archive for access only by the members of the community. Development of legacy content for integration into the legacy archive. These activities and mechanisms generate revenue. The defined community, its legacy archive, the legacy content and the revenue are products of the invention's process. The invention may further include a restricted access mechanism to the legacy archive only for the community members to create revenue. A communications access provider may further host the restricted access mechanism. The invention may include mechanisms and methods specifying and supporting at least one instance of the legacy archive, for delivery to a community member. The invention further includes specifying and creating updates to these legacy archive instances based upon legacy content provided for integration. These activities and mechanisms further generate revenue. The legacy content may further include a time capsule including a second legacy content with an instruction disabling access until a specified time.

### CROSS-REFERENCE TO PRIOR PATENT APPLICATIONS

This application claims priority as a continuation-in-part of patent application Ser. No. 10/607,708, filed Jun. 27, 2003, entitled “METHOD AND APPARATUS PROVIDING AN AVENUE FOR TERMINAL SERVICE ORGANIZATIONS TO ENLIST CUSTOMERS FOR A WEB-SERVICE”, by the inventor, which is incorporated herein by reference.

### BACKGROUND OF THE INVENTION

1. Field of the Invention

The present invention relates to creating legacy content for communities as well as restricted hosting of archives of legacy content for those communities.

2. Background Information

While the ability to record, copy and distribute audio, video, and textual information has greatly grown in the last few decades, the ability of communities to cohesively document, communicate and preserve their internal culture experiences has not kept up.

Almost every community suffers under a barrage of information, images and sounds, from mass media, which floods their members' lives. Most people know extensive details about the life histories of popular television shows, music groups, or sporting champions. However, almost no one is a sporting champion or entertainment star. We each belong to communities of people, not larger-than-life icons.

Most communities do not possess the technical means for making legacies, which can reveal their insights and struggles through time. Most people in the United States no longer know about the first automobile or airplane ride their family took. Many do not even know what their ancestors looked like when they were infants, or what they looked like when they married. Most people do not know what their ancestors' hobbies were. Most have never seen the inside of their ancestors' homes.

Yet, languishing in closets, storerooms and attics are the records and artifacts of these people. These records and objects are inaccessible to many who could benefit from knowing they are not alone in facing this modern era, with its uncertain economics, wars of mass destruction, and sea of strangers.

The development of the Internet and World Wide Web has lead to a proliferation of web-services. Yet these services do not include interactive support services for developing oral histories, organizing and laying out one or more media to create legacy content. The extent of the need is large. While there are numerous word processors, image processing and web content development software packages, most people have limited skills and/or limited time and/or limited equipment for such activities.

Meanwhile, legacy research and development capabilities exist in a wide cross section of people, who do not possess the avenue by which they can contract their services with those who need them. Today, mass media and advertising organizations provide essentially the only avenues by which most trained journalists, photographers, editors, and layout artists can make a living. Such organizations do not typically support families and communities building their cultures. The people with the need have no ready mechanism by which to contract those people with the skills and equipment to satisfy those needs.

While various password and intrusion protection schemes have surfaced, there remains a central security problem. Internet and World Wide Web access to confidential information continues to be compromised, presenting a long term vulnerability. Fundamentally secure delivery mechanisms are needed, which can reliably host the legacies of families and communities.

To summarize, efficient, easy to use mechanisms and methods are needed to develop legacy archives for restricted access by communities. Mechanisms and methods are needed, to develop and integrate legacy content for these communities. The legacy content development mechanisms can provide ways for people with the needed skills and equipment, to aid communities in telling their individual and collective stories, document their lives, times and struggles. These archives need to be protected from external intrusion, if these communities are to entrust their legacies for now and future generations.

### BRIEF SUMMARY OF THE INVENTION

The invention includes mechanisms and methods supporting the following. A first party defining members of a community. Development of at least one legacy archive for access only by the members of the community. Development of legacy content for integration into the legacy archive. These activities and mechanisms generate revenue. The defined community, its legacy archive, the legacy content and the revenue are the products of the invention's business methods.

The invention may further include providing a restricted access mechanism to the legacy archive only for the community members. The restricted access mechanism and/or its provider generate revenue from these activities. A communications access provider may further host the restricted access mechanism.

Development of the legacy content may preferably include the following. A second party specifying the development of the legacy content by at least one instruction. The second party is a community member. The second party receives a job estimate. The second party provides a financial commitment based upon the job estimate. The financial commitment at least partly contributes to revenue.

The first party and the second party in certain circumstances may be the same.

The second party may further, preferably interact with an instruction form to create the instructions. The instruction form may further include any member of the instruction form collection, comprising an interview questionnaire, a recording session questionnaire, an editing questionnaire, a content entry questionnaire, a web page layout questionnaire, and a web page system questionnaire.

Development of the legacy archive preferably includes the following. The first party and/or second party specifying the legacy archive development by at least one instruction. The specifying party receives a job estimate. This party provides a financial commitment, based upon the job estimate, which at least partly contributes to the revenue. This party may further, preferably interact with an instruction form, to create the instructions. The instruction form may further include any member of the legacy archive instruction form collection comprising a legacy archive web page layout questionnaire, a legacy archive host system questionnaire, and a legacy content integration questionnaire.

Development of legacy content may preferably include the following. Integrating the legacy content based upon instructions created using the legacy content integration questionnaire.

The invention may preferably include mechanisms and methods specifying and supporting at least one instance of the legacy archive, for delivery to a member of the community. The invention further includes specifying and creating updates to these legacy archive instances based upon legacy content provided for integration. These activities and mechanisms further generate revenue. The update may preferably include legacy content for integration into the legacy archive available after the creation of the legacy archive instance and/or a previous update.

The legacy archive instances may preferably include means for storing a version of the legacy content communicatively coupled with means for presenting the legacy content. The legacy content version may preferably at least include a compression of the legacy content. Compression may include, but is not limited to compression of audio, still frame, motion video and text based content. The legacy archive instance further preferably includes a means for decompressing the legacy content compression.

The legacy content may further include a time capsule including at least one second legacy content with an instruction disabling access until a specified time. The specified time may include a date-time. The date-time may be based upon at least one of the event collection including a birthday, a wedding day, a birth of a child, the death and/or funeral of a specified member of the community. The time capsule may further include an access instruction specifying at least one access-enabled member of the community, enabling access to the legacy content after the specified time.

### BRIEF DESCRIPTION OF THE DRAWINGS

FIG. 1 shows a business method and system, generating revenue based upon operating a legacy content service involving a community;

FIG. 2A shows a content collection for legacy content of FIG. 1;

FIG. 2B shows a community type collection for community members of FIG. 1;

FIG. 2C shows an alternative embodiment of the system of FIG. 1;

FIG. 3A shows some details of the program system of FIG. 2C;

FIG. 3B shows a further detail of the program system of FIGS. 2C and 3A;

FIG. 4A shows an alternative embodiment of the means for providing restricted access only to the community members of FIG. 1;

FIG. 4B shows further preferred details of the system of FIG. 2C;

FIG. 5 shows an example instruction form used to generate instructions;

FIG. 6A shows a request media collection of media for the instruction form of FIG. 5;

FIG. 6B shows an interface collection whose members may be includes in the interfaces to the parties of FIG. 4B;

FIG. 6C shows an instruction form collection, to which various parts of the instruction form may belong;

FIG. 6D shows a legacy archive instruction form collection for parts of the instruction form pertaining to at least developing legacy archives;

FIG. 7A shows an instance of a legacy archive;

FIG. 7B shows the legacy content including a time capsule;

FIG. 7C shows an event collection, to which the specified time of the time capsule of FIG. 7B may be related;

FIG. 7D shows details of the job estimate of FIG. 4B;

FIGS. 8A and 8B show detail flowcharts of FIG. 3A;

FIG. 8C shows a detail flowchart of FIG. 8A;

FIGS. 9A and 9B show detail flowcharts of FIG. 3A for purchasing instances of legacy archives and updates to the legacy archives instances;

FIG. 10A shows a detail flowchart of FIG. 8A for job estimates and financial commitments creating revenues;

FIG. 10B shows a detail flowchart of FIG. 10A for notifying service providers of instructions and receiving job estimates;

FIG. 11A shows a detail flowchart of FIG. 10A for creating legacy content based upon financial commitment and instructions;

FIG. 11B shows a detail flowchart of FIG. 8A showing creating the legacy content by at least one of the following: recording, interviewing and/or editing;

FIG. 12A shows members of the presentation means collection, which may be included in the presentation means of FIG. 7A;

FIG. 12B shows members of a version collection, which may be included in the version of the legacy content in the means for storing of FIG. 7A;

FIG. 12C shows a refinement of the legacy archive instance of FIG. 7A.

### DESCRIPTION OF THE PREFERRED EMBODIMENTS

The invention may include mechanisms and methods supporting the following. A first party defining members of a community. Development of at least one legacy archive for access only by the community members. Development of legacy content for integration into the legacy archive. These activities and mechanisms generate revenue. The defined community, its legacy archive, the legacy content and the revenue are the products of the invention's business methods.

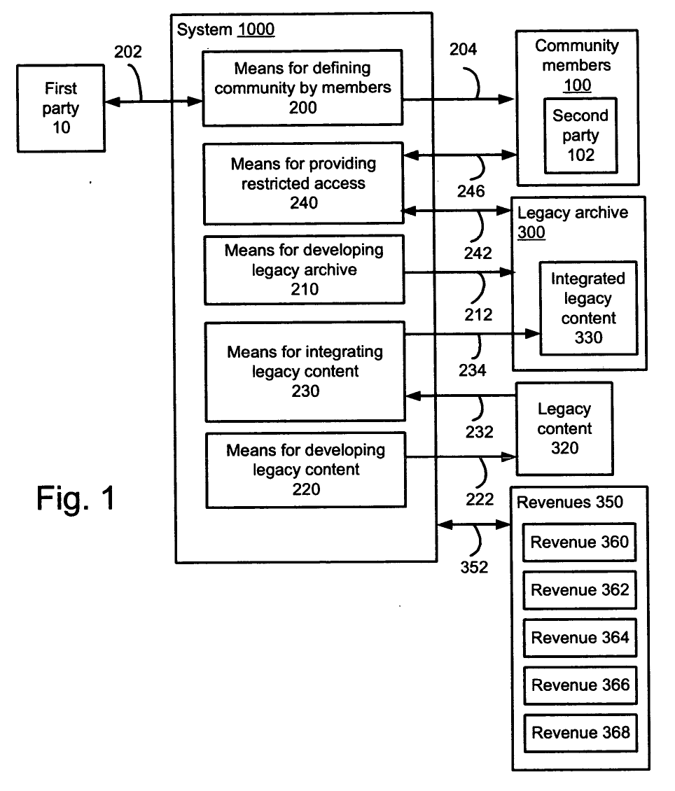

In FIG. 1, the invention's system 1000 supports a business method including the following.
A first party 10 interacts 202 with a means 200 for defining 204 a community 100 by its members.
A means 210 for developing 212 at least one legacy archive 300 for access only by the members of the community.
A means 220 for developing 222 at least one legacy content 320.
A means 230 for integrating 232 the legacy content 320 into 234 the legacy archive 300 to create the integrated legacy content 330.
These activities and mechanisms generate 352 at least one of the revenues 350.
The defined community 100, its legacy archive 300, the legacy content 320, integrated legacy content 330, and the revenues 350 are the products of the invention's business method and system 1000.

The system 1000 of FIG. 1 may further include a means 240 for accessing 242 the legacy archive 300 restricted to 246 the community members 100, for revenue 368. A communications access provider may also host the restricted access mechanism 240, for revenue 368.

The revenues 350 of FIG. 1 may include any combination of the following.
A first revenue 360 may be created by the first party 10 interacting 202 to define 200 the community members 100.
A second revenue 362 may be created by developing 210 the legacy archive 300.
A third revenue 364 may be created, by developing 220 at least one legacy content 320 for integration 230 into 234 the legacy archive 300.
A fourth revenue 236 may be created by integrating 230 the legacy content 320 into 234 the legacy archive 300 to create an integrated legacy content 330 included in the legacy archive 300.
A fifth revenue 368 may be created, by providing access 240 to 242 the legacy archive 300 restricted to only 246 the community members 100.

The first party 10 and the second party 102 of FIG. 1 in certain circumstances may be the same.

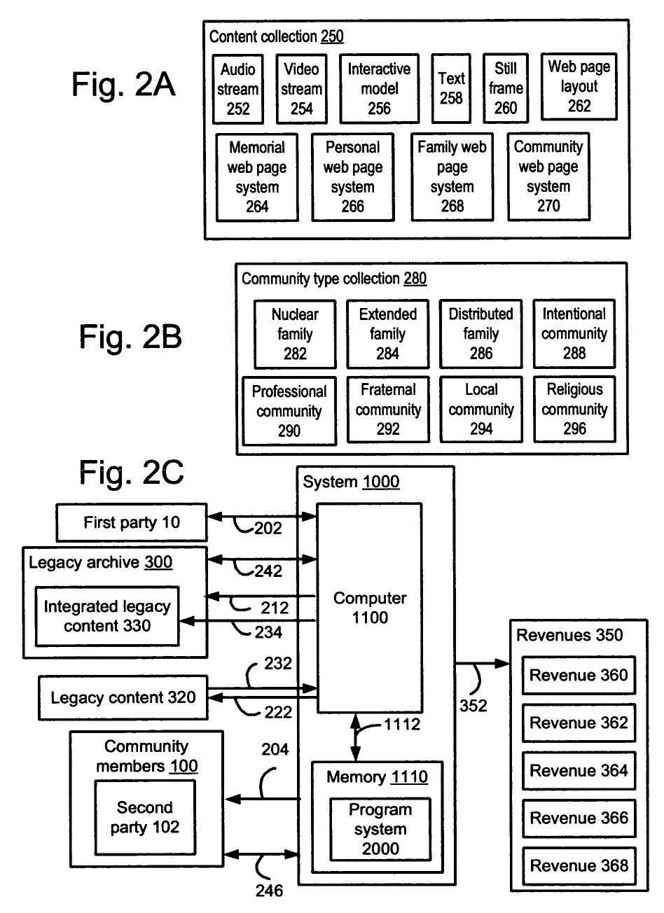

Each of the legacy contents 320 of FIG. 1 includes at least one instance of a member of the content collection 250 of FIG. 2A. The content collection 250 includes the following: an audio stream 252, a video stream 254, an interactive model 256, a text 258, a still frame 260, a web page layout 262, a memorial web page system 264, a personal web page system 266, a family web page system 268, and a community web page system 270.

Each of the community members 100 of FIG. 1 is a member of at least one instance of a community type collection 280 of FIG. 2B. The community type collection 280 includes the following: a nuclear family 282, an extended family 284, a distributed family 286, an intentional community 288, a professional community 290, a fraternal community 292, a local community 294, and a religious community 296.

FIG. 2C shows an alternative to the system 1000 of FIG. 1, including a computer 1100 communicatively coupled to 202 the first party 10 and to 242 the legacy archive 300. The system 1000 also includes a memory 1110 accessibly coupled to 1112 the computer 1100. A program system 2000 directs the computer 1100 by program steps residing in the memory 1110.

As used herein, a computer includes at least one instance of a member of the collection comprising an instruction processor, an inferential engine, a neural network, and a finite state machine. An instruction processor includes at least one instruction processing element and at least one data processing element; wherein each of the data processing elements is controlled by at least one of the instruction processing elements.

The following figures include flowcharts of at least one method of the invention possessing arrows with reference numbers. These arrows signify the flow of control and sometimes data. The arrows support implementations including at least one program step or program thread executing upon a computer, inferential links in an inferential engine, state transitions in a finite state machine, and learned responses within a neural network.

The step of starting a flowchart refers to at least one of the following.
Entering a subroutine in a macro instruction sequence in a computer.
Entering a deeper node of an inferential graph.
Directing a state transition in a finite state machine, possibly while pushing a return state.
Triggering at least one neuron in a neural network.

The step of termination in a flowchart refers to at least one of the following.
Return from a subroutine.
Traversal to a higher node in an inferential graph.
Popping of a previously stored state in a finite state machine.
Return to dormancy of the firing neurons of the neural network.

Alternatively, a source step of an arrow pointing to termination, may be the only step represented in the flowchart. Alternatively, one or more of the other steps may execute, either sequentially or concurrently, to implement the method of the invention.

A step in a flowchart refers to at least one of the following.
The instruction processor at least partly implements the step by responding to the program steps to control the data execution unit.
The inferential engine at least partly implements the step by responding to the program steps as nodes and transitions within an inferential graph based upon and modifying an inference database.
The neural network at least partly implements the step by responding to the program steps as stimulus.
The finite state machine at least partly implements the step by responding to the program steps through at least one of a state and a state transition.

The memory referred to herein includes at least one instance of at least one member of a memory type collection comprising: a non-volatile memory, and a volatile memory. A non-volatile memory includes at least one memory state retained without applying a power source to the non-volatile memory. The volatile memory includes at least one memory state lost without applying the power source to the volatile memory.

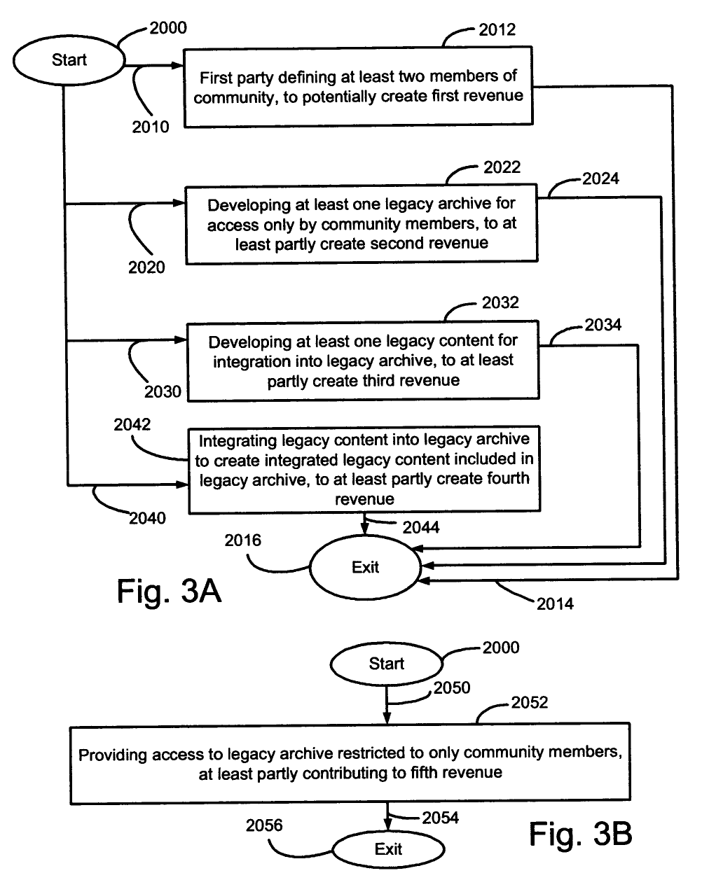

FIG. 3A illustrates a flowchart of program system 2000 of FIG. 2C for generating at least one revenue 350 based upon operating a legacy content service involving the community 100 of FIGS. 1 and 2C.
Operation 2012 supports the first party 10 defining 204 at least two community members 100, to potentially create the first revenue 360.
Operation 2022 supports developing 212 at least one legacy archive 300 for access only by the community members 100, to at least partly create the second revenue 362.
Operation 2032 supports developing 222 at least one legacy content 320 for integration into the legacy archive 300, to at least partly create the third revenue 364.
Operation 2042 supports integrating 242 the legacy content 320 into 246 the legacy archive 300 to create an integrated legacy content 330 included in the legacy archive 300, to at least partly create the fourth revenue 366.

FIG. 3B illustrates a refinement of the flowchart of program system 2000 of FIGS. 2C and 3A providing access to the legacy archive restricted to only the community members 100 of FIGS. 1 and 2C. Operation 2052 supports providing access to the legacy archive restricted to only the community members, at least partly contributing to the fifth revenue 368.

The invention includes at least one of the means of FIG. 1 including at least one computer controlled by a program system including program steps residing in a memory accessibly coupled with the computer. The program steps at least partially implement the means.

One skilled in the art will recognize that the means 200, 210, 220, 230 and 240 of FIG. 1, may or may not be owned and/or operated by separate enterprises or individuals. The revenues 350 to 368 are thus products of the process received by these enterprises or individuals.

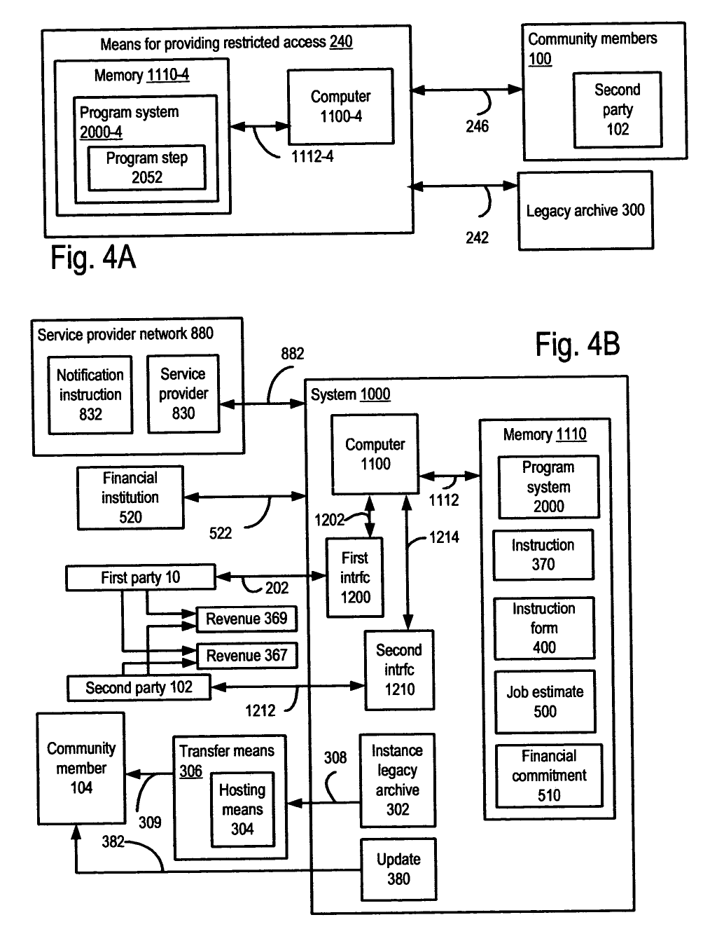

By way of example, FIG. 4A shows means 240 of FIG. 1 including computer 1100-4 controlled by a program system 2000-4, including program step 2052 residing in a memory 1110-4, accessibly coupled 1112-4 with the computer 1100-4.

The means of FIGS. 1 and 4A may further include
the computer 1100-4 communicatively coupled 202 to the first party 10, as in FIG. 1 for means 200, and/or
the computer 1100-4 communicatively coupled 246 to the second party 102, as in FIG. 4A for means 240.

Development of the legacy content as shown in FIG. 4B preferably includes the following.
A second party 102 specifying 1212 the development of the legacy content 320 by at least one instruction 370. The second party 102 is a community member 100 as shown in FIG. 1.
The second party 102 receiving 1212 a job estimate 500.
The second party 102 providing 1212 a financial commitment 510 based upon the job estimate 500, which at least partly contributes to the revenue 364.

Aspects of the invention shown in FIG. 4B include:
an interface 1200 with the first party 10 and/or
an interface 1210 with the second party 102.

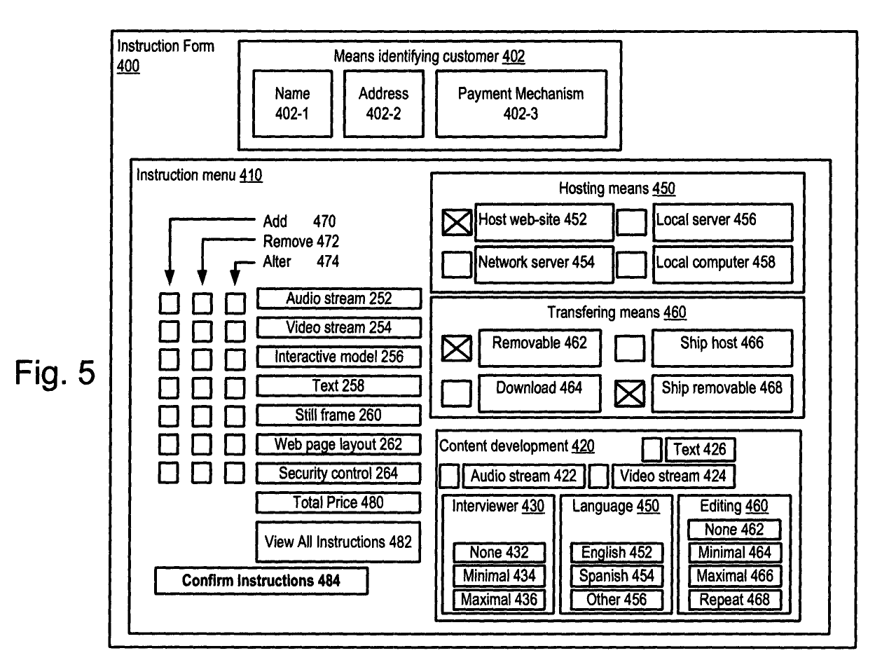

These interfaces 1200 and/or 1210 are at least partly implemented as an instruction form 400, as shown in FIGS. 4B and 5.

The instruction form 400 of FIG. 4B and 5 preferably includes:
Means 402 for identifying the customer 10, and/or 102, to the system 1000 and/or means 200, 210, 220, 230, and/or 240.
Means 410 for providing the instruction 370 to the system 1000 and/or means 200, 210, 220, 230, and/or 240.

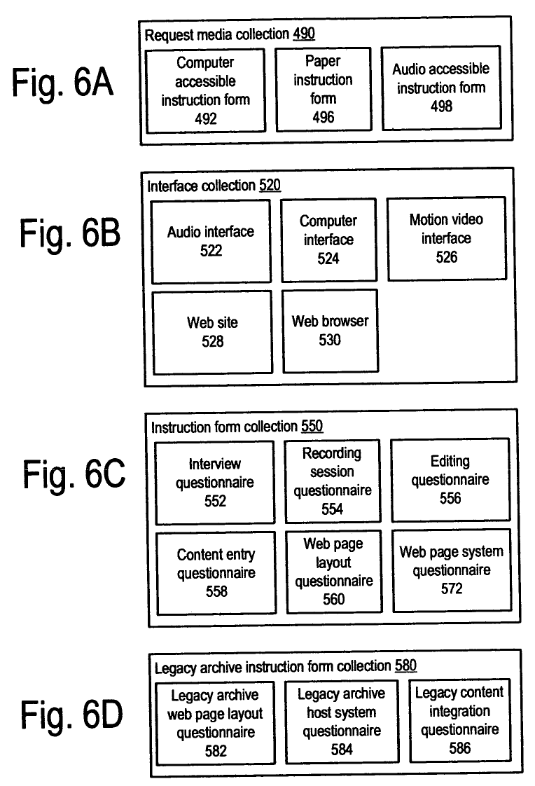

At least one of the interfaces 1200 and/or 1210 is a member of the interface collection 520 of FIG. 6B. The interface collection 520 includes an audio interface 522, a computer interface 524, a motion video interface 526, a web site 528, and a web browser 530.

The second party 102 may further preferably interact 1212 with an instruction form 400 to create the instructions 370, as shown in FIGS. 4B and 5. The instruction form 400 may further include any member of the instruction form collection 550 of FIG. 6C. The instruction form collection 550, may include an interview questionnaire 552, a recording session questionnaire 554, an editing questionnaire 556, a content entry questionnaire 558, a web page layout questionnaire 560, and a web page system questionnaire 562.

The instruction form 400 of FIG. 5, is a schematic example of how a customer may instruct 370
the providing of legacy archives 300,
the developing of legacy content 320, and
the purchasing of legacy archive instances 302.

The instruction form 400 of FIG. 5, is a member of the request media collection 490 shown in FIG. 6A. The request media collection includes a computer accessible instruction form 492, a paper instruction form 496, and an audio accessible instruction form 498.

Note that a community member 100 may be the second party 102 for any combination of the following services provided by the invention:
providing the legacy archive 300,
developing legacy content 320,
integrating content 330 into the legacy archive 300, and/or
purchasing legacy archive instances 302.

The means for receiving 352 one or more of the revenues 350-368 of FIGS. 1 and 2C, preferably includes at least one of the following in many aspects of the invention:
Means for a bank account controlled by an organization, which operates and/or owns one of the means of FIGS. 1, 2C, 4A and/or 4B, and receives a monetary transfer of one of the revenues,
Means for the organization receiving a check for one or more of the revenues.

The revenues 350-368 of FIGS. 1 and 2C, may be further based upon any combination of the following:
More than one first party 10,
More than one second party 102,
More than one system 1000 and/or means 200, 210, 220, 230, and/or 240
More than one legacy archive 300, and/or
More than one legacy content 320.

FIG. 5 shows a preferred instruction form 400 of FIG. 4B, including the following, means 402 for identifying the customer, the first party 10 and/or the second party 102, to the system 1000 and/or means 200, 210, 220, 230, and/or 240.

The means 402 of FIG. 5 further includes
A name field 402-1,
An address field 402-2, and
A way for the customer to determine the payment mechanism 402-3.

The instruction 370 of FIG. 4B, is preferably created using an instruction menu 410 of the instruction form 400 of FIG. 5. The instruction menu 410 preferably includes the following:
Instruction commands add 470, remove 472, and alter 474 one or more of the following:
   an audio stream 252, a video stream 254, an interactive model 256, a text 258, a still frame 260, a web page layout 262, and a security control 264.
A total price 580 for the instruction 370.
When the instruction form 400 is a computer accessible instruction form 418, it preferably includes a View All Instructions 482 button or activator.
A means 484 for the customer to confirm paying the price 480 to create one or more of the revenues. For example,
   The revenue 362 is based at least partly upon providing the legacy archives 300, which are customized by the instructions 370.
   The revenue 364 is based at least partly upon providing the legacy content 320, which is customized by the instructions 370.

The hosting means menu 450 of FIG. 5, preferably supports the customer selecting one or more of the following as the hosting means 304 of FIG. 4B:
a host web-site 452 providing at least the legacy content 320 and/or the legacy archive 300,
a network capable server 454 for hosting the host web-site 452,
a local server 456 for hosting the host web-site 452, and/or
a local computer system 458 which provides at least the legacy content 320.

A transferring means menu 460 of FIG. 5 preferably supports the customer selecting one or more of the following for transferring means 306 of FIG. 4B:
a removable memory device 462, which contains at least one of the legacy content 320 and/or the legacy archive 300, as in FIGS. 1 and 2C,
a download 464, which contains at least the legacy content 320,
a shipping means 466 for the hosting means 304 as in FIGS. 1 and 5, and
a shipping means 468 for the removable device 462.

The content development menu 420 of FIG. 5 provides an instruction form for legacy content development, which preferably include the following:
a stream generation component, which includes at least generating an audio stream 252 and/or generating a video stream 254,
an interviewer component 430, which includes support for selecting none 432, minimal 434, or maximal 436 interviewer support,
a language component 450, which includes a first language 452, for example, English, a second language 454, Spanish, and another language 456, in which the interviewer interacts, and
an editor component 460, which includes none 462, minimal editing 464, maximal editing 466, and/or repeated editing 468.

The hosting means 304 of FIG. 4B, may include any of the following members of the hosting means collection 450, in FIG. 5:
a host web-site 452 which provides at least the legacy content 320 and/or an instance 302 of the legacy archive,
a network capable server 454 which hosts the host web-site 452,
a local server 456 which hosts the host web-site 452, and/or
a local computer system 458, which provides at least the legacy content 320 and/or an instance 302 of the legacy archive.

The transferring means 306 of FIG. 4B may include any of the transfer means collection 460 shown in FIG. 5:
A removable memory device 462 which contains the legacy content 320, the legacy archive 300 and/or an instance 302 of the legacy archive, as in FIGS. 1, 2C and 4B. Removable memory devices 462 include, but are not limited to CD-ROMs, CD-RAMs, DVD ROM and RAMs, as well as removable disk drives in all forms, including but not limited to, Compact Flash, and PCMCIA.
A download 464 containing at least the legacy content 320. The download may be in the form of sending a communication such as an email, a live update, and/or require a web browser to initiate and/or perform.
A shipping means 466 for the hosting means 304 as in FIGS. 4B and 5, and
A shipping means 468 for the removable device 462.

In certain aspects of the invention, the stream generation may further include an option 426 shown in FIG. 5, to generate a text 258 as a product of the invention's process.

The instruction form 400 of FIG. 5 may be a paper instruction form 416. In this case, the means 520 for the customer to confirm paying the price 510 may include a signature area. When the instruction form 400 is a computer accessible instruction form 412, it may include a button 484 for the customer to activate. For example, activation may entail the customer pushing the button, or pointing at the button and clicking a mouse. Alternatively, activation may involve the customer making sounds.

The details of FIG. 5, for adding 470, removing 472, or altering 474, at least one of legacy contents 252 to 264 will vary, depending upon the request media collection 410 member embodied.
When the instruction form 400 is a computer accessible instruction form 482.
   The adding 470, removing 472, or altering 474 of legacy contents 252 to 264 may trigger hyperlinks to dialogues for the customer providing the specifics of the instruction. These may include selection of files containing audio streams, video streams, still frames, and so on. In certain embodiments of the invention, inserting still frames into a scanner may be part of building the instructions.
When the instruction form 400 is a paper instruction form 416, the generation of instructions will vary.
   Attachments for still frames on computer-readable media or on paper are preferred.
   Attachments for video and audio streams on computer-readable media, various forms of magnetic tape devices, and possibly phonographic recordings are preferred.
When the instruction form 400 is an audio accessible instruction form 418, the receipt of the attachments will preferably be a delivery to complete the instructions 370.

Development of the legacy archive 300 of FIGS. 1, 2C, and 4B, preferably includes the following.
The first party 10 and/or second party 102 specifies the legacy archive 300 development by at least one instruction 370.
The customer 10 and/or 102 receives a job estimate 500.
The customer 10 and/or 102 provides a financial commitment 510, based upon the job estimate 500, which at least partly contributes to the revenue 362.

The customer 10 and/or 102 may further, preferably interact with an instruction form 400, to create instructions for developing the legacy archive.

The instruction form may further include any member of the legacy archive instruction form collection 580, as shown in FIG. 6D, including
a legacy archive web page layout questionnaire 582,
a legacy archive host system questionnaire 584, and
a legacy content integration questionnaire 586.

Development of legacy content as shown in FIGS. 1, 2C, 4B, and 6D, preferably also includes the following. Integrating 230 the legacy content 320 based upon the instructions 370, created using the legacy content integration questionnaire 586.

The invention also preferably includes mechanisms and methods specifying and supporting at least one instance 302 of the legacy archive 300, for delivery to a community member 104 as shown in FIG. 4B. The invention further includes specifying and creating updates 380 to these legacy archive instances 302 based upon legacy content 320 provided for integration 230 as shown in FIGS. 1, 2C, and 4B. These activities and mechanisms further generate revenue 366. The update 380 preferably includes legacy content 320 for integration 230 into the legacy archive 300 available after the creation of the legacy archive instance 302 and/or a previous update 380.

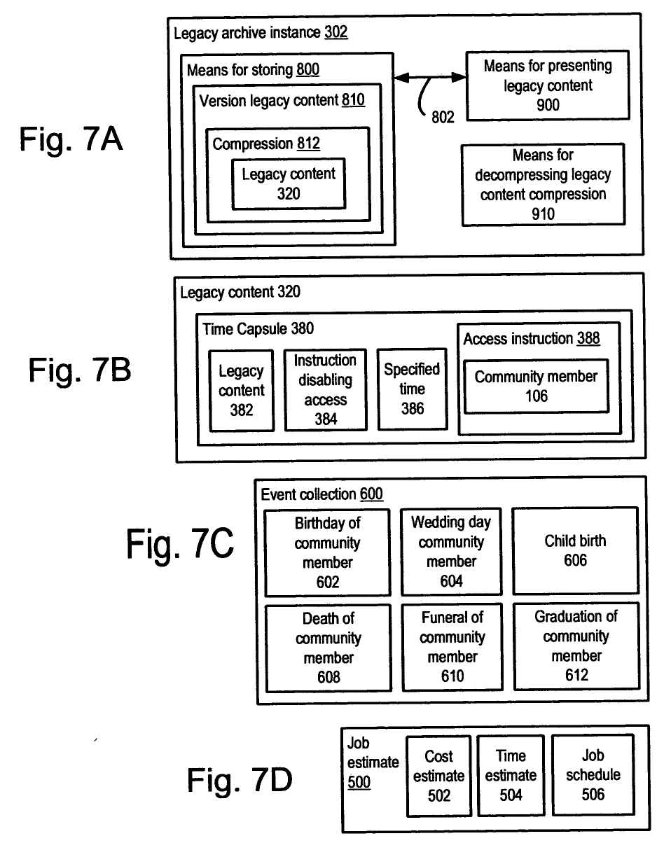

The legacy archive instances 302 of FIGS. 2C and 4B, may preferably include means for storing 800 a version of the legacy content 810. The means for storing 800 is preferably communicatively coupled 802 with the means for presenting the legacy content 900, as shown in FIG. 7A. The legacy content version 810 preferably includes a compression 812 of the legacy content 320.

The communicative coupling 802 of the means for storing 800 with the means for presenting 900 may preferably be active when presenting the legacy content. The legacy archive instance 302 may include a repository of means for storing 800, which only communicatively couples part of the stored legacy content at any one time. Such implementations are sometimes referred to as “juke boxes”.

The legacy content 320 of FIGS. 1, 2C, 4B, and 7A may further include a time capsule 380 as shown in FIG. 7B. The time capsule 380 includes at least one legacy content 382 with an instruction 384 disabling access until a specified time 386.

The specified time 386 of FIG. 7B may include a date-time based upon at least one of the event collection 600, as shown in FIG. 7C. The event collection 600 includes
a birthday of someone associated with a community member 602,
a wedding day of someone associated with the community member 604,
the birth of a child associated with the community member 606,
a death of someone associated with the community member 608,
the funeral of someone associated with the community member 610, and/or
a graduation of someone associated with the community member from an education program 612.

The time capsule 380 of FIG. 7B may further include an access instruction 388 specifying at least one access-enabled member of the community 106, for whom access to the legacy content 382 is provided after the specified time 386.

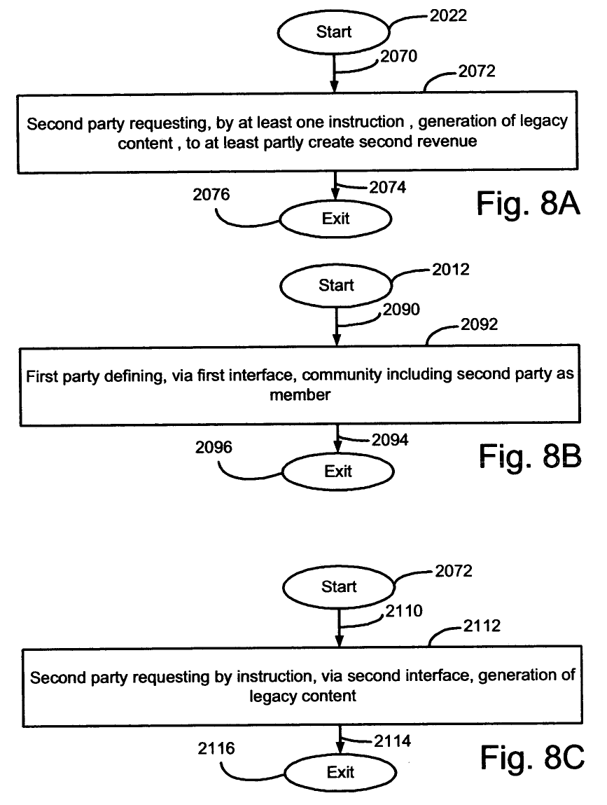

FIG. 8A illustrates a detail of 2022 of FIG. 3A further developing the legacy content 320 of FIGS. 1, 2C, and 7B. Operation 2072 supports the second party 102 requesting, by at least one instruction 370 of FIGS. 4B and 5, generation of the legacy content 320, to at least partly create the second revenue 362.

FIG. 8B illustrates a detail of 2012 of FIG. 3A further supporting, the first party 10 defining the community members 100 of FIGS. 1 and 2C. Operation 2092 supports the first party 10 defining, via a first interface 1200 of FIG. 4B, the community including the second party 10 as a member 100.

FIG. 8C illustrates a detail of 2072 of FIG. 8A of the second party 102 requesting legacy content development, as shown in FIGS. 1, 2C, and 4B. Operation 2112 supports the second party 102 requesting by the instruction 370, via a second interface 1210, generation of the legacy content 320.

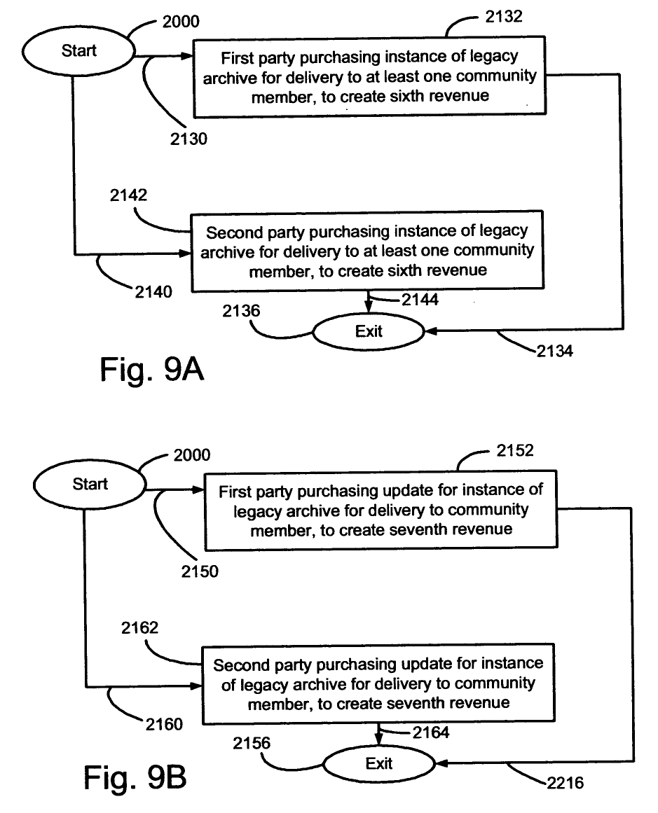

FIG. 9A illustrates a detail of the invention's method implemented by program system 2000 of FIGS. 2C, 3A, and 4B, for purchasing an instance 302 of the legacy archive 300 of FIGS. 1, 2C, 4B, and 7A.
Operation 2132 supports the first party 10 purchasing an instance 302 of the legacy archive 300 for delivery 309 to at least one community member 104, to create a sixth revenue 369.
Operation 2142 supports the second party 102 purchasing the instance 302 of the legacy archive 300 for delivery 309 to at least one community member 104, to create the sixth revenue 369.

FIG. 9B illustrates a detail of the invention's method implemented by program system 2000 of FIGS. 2C, 3A, and 4B, for purchasing an update 380 of the legacy archive instance 302 of FIGS. 4B, and 7A.
Operation 2152 supports the first party 10 purchasing an update 380 for the instance 302 of the legacy archive 300 for delivery 382 to the community member 104, to create a seventh revenue 367.
Operation 2162 supports the second party 102 purchasing the update 380 for the instance 302 of the legacy archive 300 for delivery 382 to the community member 104, to create the seventh revenue 367.

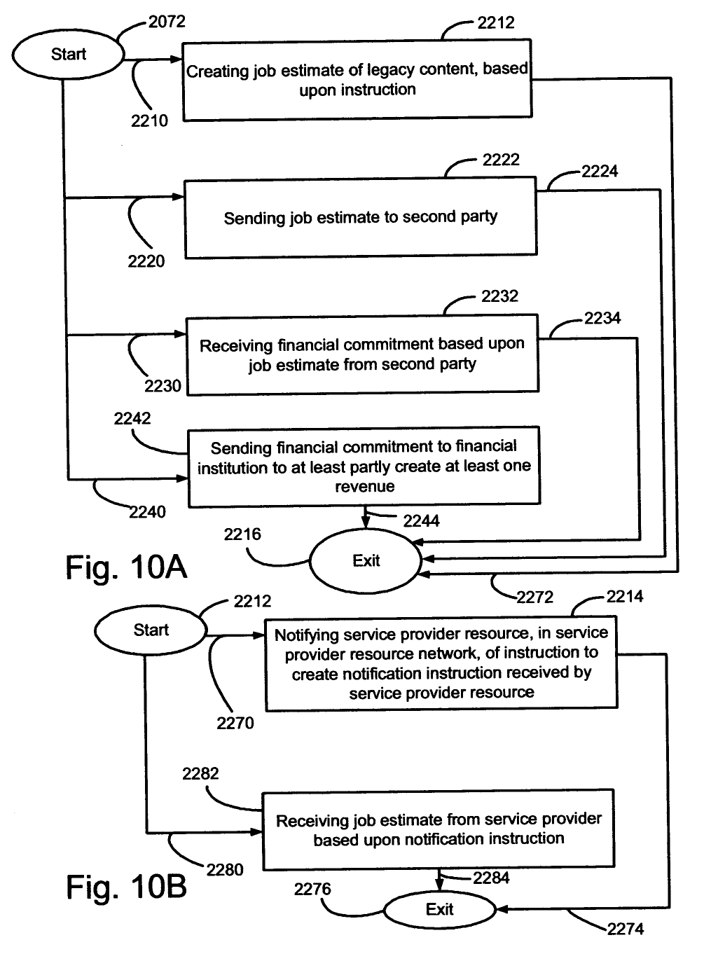

FIG. 10A illustrates a detail flowchart of operation 2072 of FIG. 8A further requesting generation of the legacy content 320 of FIGS. 1, 2C, 4B, and 7B.
Operation 2212 supports creating a job estimate 500 of the legacy content 320, based upon the instruction 370.
Operation 2222 supports sending the job estimate 500 to 202 the second party 102.
Operation 2232 supports receiving the financial commitment 510 based upon the job estimate 500 from 1212 the second party 102.
Operation 2242 supports sending the financial commitment 510 to 522 the financial institution 520 to at least partly create the revenues 350-369.

FIG. 10B illustrates a detail of operation 2212 of FIG. 10A further creating the job estimate 500 of FIGS. 4B and 7D.
Operation 2272 supports notifying 882 at least one service provider 832, included in a service provider network 880, of at least one of the instructions 370 to create the notification instruction 832 received by the service provider 830.
Operation 2282 supports receiving the job estimate 500 from 882 the service provider 830 based upon the notification instruction 832.

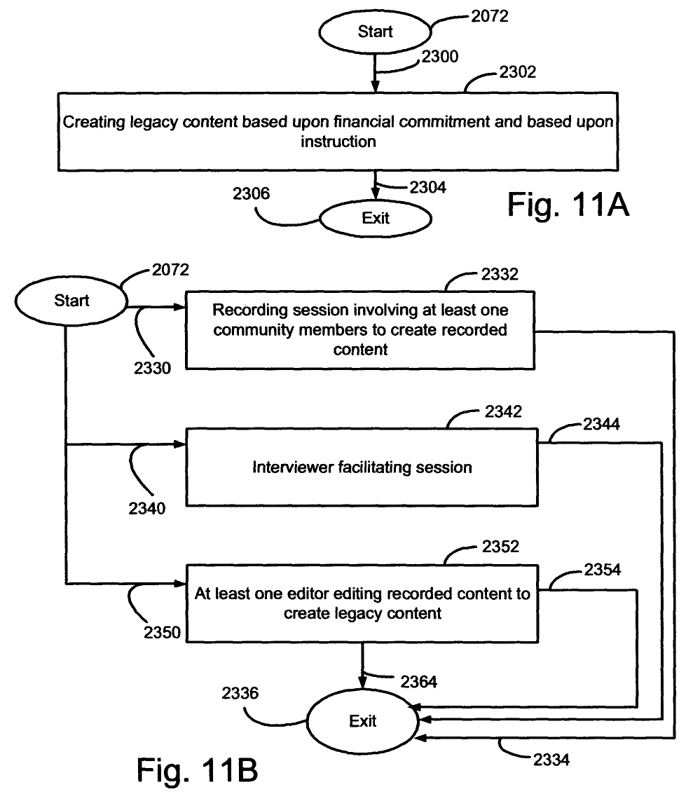

FIG. 11A illustrates a detail of operation 2072 of FIGS. 3A and 10A, further developing the legacy content 320 of FIGS. 1, 2C, 4B, and 7B. Operation 2302 supports creating the legacy content 320 based upon the financial commitment 510 and based upon the instruction 370 of FIG. 4B.

FIG. 11B illustrates a detail flowchart of operation 2072 of FIGS. 3A, 10A, and 11A, further developing the legacy content 320 of FIGS. 1, 2C, 4B, and 7B.
Operation 2332 supports recording a session involving at least one the community members to create a recorded content.
Operation 2342 supports at least one interviewer facilitating the session.
Operation 2352 supports at least one editor editing the recorded content to create the legacy content 320.

The session of FIG. 11B may be an audio session, an audio-video session, and/or a text-based interactive session. The recording of the session may create audio content, audio-video content, still frame content, and/or text content. The editing may involve any combination of content to create the legacy content 320.

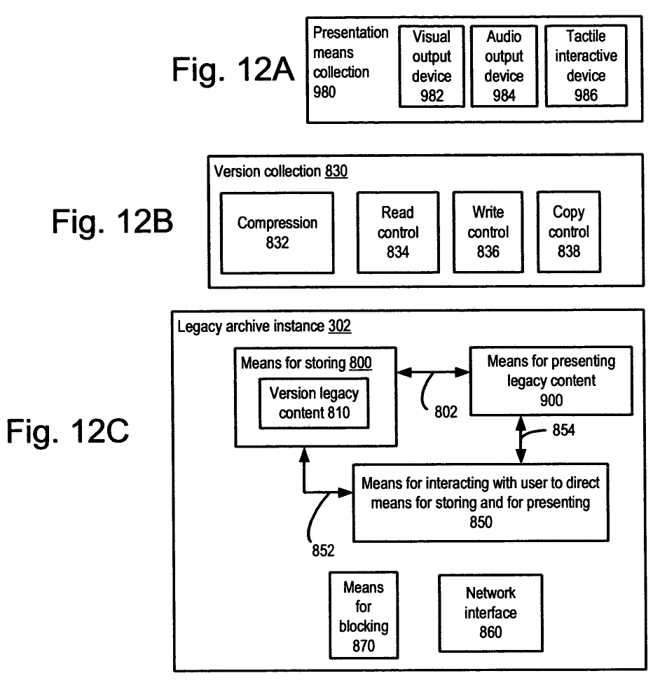

The means for presenting 900 of FIG. 7A includes at least one instance of at least one of the presentation means collection 980 of FIG. 12A which includes the following. A visual output device 982, an audio output device 984, and a tactile interactive device 986.

The means for storing 800 of FIG. 7A is comprised of a version 810 of the legacy content residing in at least one memory device. The memory device includes at least one instance of a non-volatile memory and/or at least one instance of a volatile memory.

The version of legacy content 810 of FIG. 7A implements at least one member of a version collection 830 of FIG. 12B. The version collection 810 includes: a compression 832 of the legacy content, an read control 834 for the legacy content, a write control 836 for the legacy content, and a copy control 838 for the legacy content.

The means for converting 910 the legacy content version 810 of FIG. 7A may be a separate component from the means for storing 800 and the means for presenting 900. The legacy archive instance 302 further preferably includes a means 910 for decompressing the legacy content compression 812. Alternatively, the means for converting 910 may be included in the means for storing 800. Also, the means for converting 910 may be included in the means for presenting 900.

The legacy archive instance 302 of FIGS. 4B and 7A, may further include means for interacting 850 with a user, as in FIG. 12C. The means for interacting 850
directs 852 the means for storing 800 and directs 854 the means for presenting 900.

The means for interacting 850 of FIG. 12C may preferably further include at least one user input device.

At least one of the means of FIGS. 7A and 12C may include a computer controlled by a program system including at least one program step at least partially implementing the means. The program system includes program steps residing in a memory accessibly coupled with the computer as previously discussed.

The legacy archive instance 302 of FIG. 12C may further include
a network interface 860 coupling the instance of the legacy archive to an external network, and
a means for blocking 870 communication of the legacy content 320 onto the external network.

The preceding embodiments provide examples of the invention and are not meant to constrain the scope of the following claims.

1. A system, comprising:
a computer communicatively coupled to a first party and to a legacy archive;
a memory accessibly coupled to said computer;
a program system directing said computer by program steps residing in said memory;
wherein said program system is comprised of the program steps of:
said first party defining said members of said community, to potentially create said first revenue;
developing said legacy archive for access only by said members of the community, to partly create said second revenue;
developing said legacy content for integration into said legacy archive, to at least partly create said third revenue; and
integrating said legacy content into said legacy archive to create said integrated legacy content included in said legacy archive, to at least partly create said fourth revenue.

2. The apparatus of claim 1, wherein said computer includes at least one instance of a member of the collection comprising an instruction processor, an inferential engine, a neural network, and a finite state machine;
wherein said instruction processor includes at least one instruction processing element and at least one data processing element; wherein each of said data processing elements is controlled by at least one of said instruction processing elements.

3. The apparatus of claim 1, wherein said computer is communicatively coupled to said party collection member is further comprised of at least one member of the party collection comprising:
said computer communicating via a network with said party collection member;
said computer communicating via an interface with said party collection member; and
wherein said interface includes at least one member of an interface collection comprising an audio interface, a computer interface, a motion video interface, a web site, and a web browser;
wherein said network uses at least one member of the network transport collection comprising a wireless physical transport and a wireline physical transport.

4. The apparatus of claim 1, wherein each of said legacy contents include at least one instance of a member of the content collection comprising:
a text, an audio sequence, a video-sequence, a still frame, a web page layout, a memorial web page system, a personal web page system, a family web page system, and a community web page system;

5. The apparatus of claim 1, wherein each of said members of said community is a member of at least one instance of a community type collection comprising: a nuclear family, an extended family, a distributed family, an intentional community, a professional community, a fraternal community, a local community, and a religious community.

6. The apparatus of claim 8, wherein said first party is said second party.

7. The apparatus of claim 1, wherein said program system, further comprising the program step of:
providing access to said legacy archive restricted to only said community members, at least partly contributing to a fifth of said revenues.

8. The apparatus of claim 1, wherein the program step developing said legacy content for integration into said legacy archive, further comprising the program step of:
said second party requesting, by at least one instruction, generation of a first of said legacy content, to at least partly create said second revenue.

9. The apparatus of claim 8, wherein the program step of said first party defining, is further comprised of the program step of: said first party defining, via a first interface, said community including said second party as said member;
wherein said first interface includes at least one member of an interface collection comprising an audio interface, a computer interface, a motion video interface, a web site, and a web browser;
wherein the program step of said second party requesting is further comprised of the program step of: said second party requesting by said instruction, via a second interface, generation of said legacy content;
wherein said second interface includes at least one member of said interface collection.

10. The apparatus of claim 8, wherein said program system, further comprising at least one member of the collection comprising the program steps of:
said first party purchasing an instance of said legacy archive for delivery to at least one of said community members, to create a third of said revenue;
said second party purchasing said instance of said legacy archive for delivery to said at least one community members, to create said third revenue;
wherein said instance of said legacy archive, comprises:
means for storing said legacy content communicatively coupled with at least one means for presenting said legacy content

11. A method of generating at least one revenue based upon operating a legacy content service involving a community, comprising the steps of:
a first party defining at least two members of said community, to potentially create a first of a revenue;
developing at least one legacy archive for access only by said members of the community, to at least partly create a second of said revenues;
developing at least one legacy content for integration into said legacy archive, to at least partly create a third of said revenues; and
integrating said legacy content into said legacy archive to create an integrated legacy content included in said legacy archive, to at least partly create a fourth of said revenues.

12. The method of claim 11, wherein each of said legacy contents include at least one instance of a member of the content collection comprising:
an audio stream, an interactive model, a video stream, a text, a still frame, a web page layout, a memorial web page system, a personal web page system, a family web page system, and
a community web page system.

13. The method of claim 11, wherein each of said members of said community is a member of at least one instance of a community type collection comprising: a nuclear family, an extended family, a distributed family, an intentional community, a professional community, a fraternal community, a local community, and a religious community.

14. The method of claim 11, wherein said first party is said second party.

15. The method of claim 1 1, further comprising the step of:
providing access to said legacy archive restricted to only said community members, at least partly contributing to a fifth of said revenues.

16. The method of claim 11, wherein the step developing said legacy content, further comprising the step of:
said second party requesting, by at least one instruction, generation of a first of said legacy content, to at least partly create said second revenue.

17. The method of claim 16, wherein the step of said first party defining, is further comprised of the step of: said first party defining, via a first interface, said community including said second party as said member;
wherein said first interface includes at least one member of an interface collection comprising an audio interface, a computer interface, a motion video interface, a web site, and a web browser;
wherein the step of said second party requesting is further comprised of the step of: said second party requesting by said instruction, via a second interface, generation of said legacy content;
wherein said second interface includes at least one member of said interface collection.

18. The method of claim 16, further comprising at least one member of the collection comprising the steps of:
said first party purchasing an instance of said legacy archive for delivery to at least one of said community members, to create a sixth of said revenue;
said second party purchasing said instance of said legacy archive for delivery to said at least one community members, to create said sixth revenue;
wherein said instance of said legacy archive, comprises:
means for storing said legacy content communicatively coupled with at least one means for presenting said legacy content, for at least one of said legacy content integrated into said legacy archive.

19. The method of claim 18, wherein said means for storing further includes means for storing each of said legacy contents integrated into said legacy archive.

20. The method of claim 18, wherein said means for presenting includes at least one instance of at least one member of the presentation means collection comprising, a visual output device, an audio output device, and a tactile interactive device.

21. The method of claim 18, wherein said means for storing is comprised of a version of said legacy content residing in at least one memory device; wherein said memory device includes an instance of a member of the memory type collection comprising a non-volatile memory and a volatile memory.

22. The method of claim 21, wherein said version of said legacy content implements at least one member of a version collection comprising: a compression of said legacy content, an read control for said legacy content, a write control for said legacy content, and a copy control for said legacy content.

23. The method of claim 18, wherein said legacy archive further comprises a means for interacting with a user to collectively direct said means for storing and said means for presenting said legacy content.

24. The method of claim 23, wherein said means for interacting further comprises: at least one user input device presenting actions of a user to a means for controlling said legacy archive; wherein said means for controlling is communicatively coupled with said means for storing and with said means for presenting.

25. The method of claim 24, wherein at least one of said means further comprises a computer controlled by a program system including program steps residing in a memory accessibly coupled with said computer; wherein at least one of said program steps at least partially implements said means;
wherein said computer includes at least one instance of a member of the collection comprising an instruction processor, an inferential engine, a neural network, and a finite state machine;
wherein said instruction processor includes at least one instruction processing element and at least one data processing element; wherein each of said data processing elements is controlled by at least one of said instruction processing elements.

26. The method of claim 20, wherein said instance of said legacy archive, further comprises:
a network interface coupling said instance of said legacy archive to an external network; and
a means for blocking communication of said legacy content onto said external network.

27. Said instance of said legacy archive delivered to said community member, and said sixth revenue, as products of the process of claim 18.

28. The method of claim 18, further comprising at least one member of the collection comprising the steps of:
said first party purchasing an update for said instance of said legacy archive for delivery to said community member, to create a seventh of said revenues;
said second party purchasing said update for said instance of said legacy archive for delivery to said community member, to create said seventh revenue.

29. Said update, and said seventh revenue as products of the process of claim 28.

30. The method of claim 16, wherein the step said second party requesting generation of said legacy content, further comprising the steps of:
creating a job estimate of said legacy content, based upon said instruction;
sending said job estimate to said second party;
receiving a financial commitment based upon said job estimate from said second party; and
sending said financial commitment to a financial institution to at least partly create at least one of said revenues.

31. The method of claim 30, wherein the step creating said job estimate further comprises the steps of:
notifying at least one service provider, included in a service provider network, of at least one of said instructions to create said notified instruction received by said service provider; and
receiving said job estimate from said service provider based upon said notified instruction.

32. The method of claim 30, wherein said job estimate includes a cost estimate.

33. The method of claim 32, wherein said job estimate further includes a member of the collection comprising a time estimate and a job schedule.

34. Said job estimate as a product of the process of claim 30.

35. The method of claim 30, wherein the step developing said legacy content further comprising the step of:
creating said legacy content based upon said financial commitment and based upon said instruction, further comprising at least one member of a legacy creation collection comprising the steps of:
recording a session involving at least one said community members to create a recorded content;
at least one interviewer facilitating said session; and
at least one editor editing said recorded content to create said legacy content.

36. Said community, said legacy content, said legacy archive, said integrated legacy content, and said revenue, as products of the process of claim 11.

37. A system implementing the method of claim 16, comprising:
means for said first party directing said legacy archive, to create said first revenue;
means for said second party requesting, by said instruction, generation of said legacy content, to create said second revenue;
means for integrating said legacy content into said legacy archive; and
means for providing access to said legacy archive only to said client identified as said community member.

38. The apparatus of claim 37, wherein at least one of said means includes at least one computer controlled by a program system including program steps residing in a memory accessibly coupled with said computer; wherein at least one of said program steps at least partially implements said means.

39. The apparatus of claim 38, wherein said computer is communicatively coupled to at least one member of said community.

40. The apparatus of claim 38, wherein said computer is communicatively coupled to at least one member of the party collection comprising said first party and said second party.

41. The apparatus of claim 38, wherein said computer includes at least one instance of a member of the collection comprising an instruction processor, an inferential engine, a neural network, and a finite state machine;
wherein said instruction processor includes at least one instruction processing element and at least one data processing element; wherein each of said data processing elements is controlled by at least one of said instruction processing elements.

42. The apparatus of claim 38, wherein said computer is communicatively coupled to said party collection member is further comprised of at least one member of the party collection comprising:
said computer communicating via a network with said party collection member;
said computer communicating via an interface with said party collection member; and
wherein said interface includes at least one member of an interface collection comprising an audio interface, a computer interface, a motion video interface, a web site, and a web browser;
wherein said network uses at least one member of the network transport collection comprising a wireless physical transport and a wireline physical transport.

43. A system implementing the method of claim 11, comprising:
a computer communicatively coupled to said first party and to said legacy archive, further comprising:
a memory accessibly coupled to said computer;
a program system directing said computer by program steps residing in said memory;
wherein said program system is comprised of the program steps of:
said first party defining said members of said community, to potentially create said first revenue;
developing said legacy archive for access only by said members of the community, to partly create said second revenue;
developing said legacy content for integration into said legacy archive, to at least partly create said third revenue; and
integrating said legacy content into said legacy archive to create said integrated legacy content included in said legacy archive, to at least partly create said fourth revenue.

44. The method of claim 11, wherein said legacy content is comprised of a time capsule including at least one second legacy content with an instruction disabling access until a specified time.

45. The method of claim 44, wherein said time capsule further includes an access instruction specifying at least one access-enabled member of the community, enabling access to said second legacy content after said specified time.

46. A program system implementing at least part of the method of claim 11, comprising program steps residing in a memory, wherein said program system comprises the at least one of the program steps of:
said first party defining said at least two members of said community, to potentially create said first revenue;
developing said at least one legacy archive for access only by said members of the community, to at least partly create said second revenue;
developing said at least one legacy content for integration into said legacy archive, to at least partly create said third revenue; and
integrating said legacy content into said legacy archive to create said integrated legacy content included in said legacy archive, to at least partly create said fourth revenue.

47. Said program system of claim 46, further comprising said program steps residing in a non-volatile memory location within said memory.

48. Said program system of claim 47, further comprising said program steps residing in a removable memory device containing said non-volatile memory location.

49. Said program system of claim 46, further comprising said program steps residing in a removable memory device containing said memory.

50. Said program system of claim 46, comprising the program steps of:
said first party defining said at least two members of said community, to potentially create said first revenue;
developing said at least one legacy archive for access only by said members of the community, to at least partly create said second revenue;
developing said at least one legacy content for integration into said legacy archive, to at least partly create said third revenue; and
integrating said legacy content into said legacy archive to create said integrated legacy content included in said legacy archive, to at least partly create said fourth revenue.
